(19) United States
(12) Patent Application Publication
(10) Pub. No.: US 2007/0171053 A1
(43) Pub. Date: Jul. 26, 2007

(54) Escape route monitoring system with an escape door

(75) Inventor: Hartmut Heppeler, Albstadt (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: ASSA ABLOY Sicherheitstecnik GmbH

(21) Appl. No.: 11/598,198

(22) Filed: Nov. 13, 2006

(30) Foreign Application Priority Data
Nov. 11, 2005 (DE) 10 2005 053 923.8

(51) Int. Cl. G08B 13/00

(52) U.S. Cl. 340/541

(57) ABSTRACT

The present invention relates to an evacuation route monitoring system for monitoring an evacuation route having an escape door. To provide protection against unauthorized passage and/or actuation of an escape door, an evacuation route monitoring system having an escape door is specified, which comprises a monitoring unit, which monitors a predefined escape door security area, which is situated directly in front of the escape door, and which outputs at least a local signal if an object is present in the escape door security area. Furthermore, the present invention relates to a method for monitoring an evacuation route having at least one escape door, in which an escape door security area of the evacuation route is predefined in front of the escape door, this area is monitored in such a way that a presence of an object in the area is recognized, and a local signal is output as soon as a presence is recognized.

The present invention relates to a system for deterring persons from actuating an escape door of an evacuation route, a method for deterring persons from actuating an escape door of an evacuation route, and a use of a monitoring unit.

Evacuation routes having escape doors are a fixed component of emergency plans in public buildings. These evacuation routes must be continuously passable, which means that the escape doors must always be openable in the escape direction. This means that the escape doors may not be blocked and, in addition, that fleeing persons must be able to actuate and open the escape door from the escape or panic side without the aid of contrivances, such as keys, key cards, etc. Depending on the type of the public building, this is required, for example, by DIN EN 179 or DIN EN 1125.

The problem resulting from this is to be able to protect the escape doors from unauthorized passage in spite of the required ability to pass in the escape direction. It is therefore the object of the present invention to specify a system, using which the ability to pass an evacuation route and the ability to open the escape door located therein in the escape direction is ensured at all times and, simultaneously, protection against unauthorized passage and/or actuation of the escape door is provided.

This object is achieved by a system for deterring persons from actuating an escape door of an evacuation route which comprises a monitoring unit, which monitors a predefined escape door security area, which is located directly in front of the escape door in the escape direction, for passage by persons, the escape door security area being predefined in such a way that a person who wishes to pass the escape door in the escape direction must penetrate into the escape door security area, and which, upon passage of the escape door security area by a person, outputs at least a local warning signal to deter the penetrating person from actuating the escape door as long as the person is located in the escape door security area and turns off the local warning signal as soon as the person leaves the escape door security area again.

The basic idea of the present invention is accordingly to monitor, using a monitoring unit, whether at least one person is present in a predefined area of an evacuation route, the term object also referring to physical objects in addition to persons in the following. This area is monitored to secure the escape door from unauthorized opening, i.e., the escape door security area is expediently predefined in such a way that a person who wishes to actuate and pass the escape door must pass this area. In addition, the monitoring is to establish when persons or physical objects are located in the evacuation route area in an unauthorized way. Thus, for example, physical objects placed in the evacuation route and particularly in the area of the escape door may result in unobstructed passage of the evacuation route and/or correct ability to open the escape door not being provided in an emergency.

The monitoring unit is implemented in such a way that it recognizes both objects which are already located in the escape door security area upon startup of the monitoring unit and also objects which first penetrate into the escape door security area during operation. For example, if a person penetrates into the escape door security area, and/or if a person is already located in the escape door security area upon startup, the evacuation route monitoring system, in the form of a system for deterring persons from actuating an escape door of an evacuation route, outputs a local signal which, like an alarm, warns the person stopping in the escape door security area that he is about to actuate an escape door. Simultaneously, other persons located nearby are made aware of the actuation of the escape door by the penetrating person. The inhibition threshold for actuation of the escape door is thus increased. The system according to the present invention thus deters unauthorized persons from passing the escape doors and thus offers higher security against unauthorized passage of the escape door. Furthermore, it protects against unintentional passage of the escape doors, since it makes persons who are about to actuate the escape door aware of this already before the actuation of the escape door.

Overall, the frequency of unauthorized escape door actuation is thus significantly reduced. This is advantageous since a main alarm in the building is frequently triggered upon every actuation of an escape door, which in turn results in further consequences, for example, evacuation of a building or of parts of a building, triggering of an unintentional alarm, checking the alarm message (e.g., through an inspection on location or by checking video camera recordings), etc. Furthermore, persons are thus kept from using evacuation routes in normal situations, since these are frequently reserved exclusively for emergency situations.

A further advantage of the present invention is that persons are notified when they position or place physical objects in the area of the escape doors, which result in blocking of the escape door and/or may represent a source of danger for fleeing persons in an emergency. For example, for an escape door which leads directly to the outside from a building, the monitoring unit will recognize that a physical object has penetrated into the escape door security area when, for example, a person positions his motor vehicle or similar object directly in front of the escape door, so that this is blocked and may no longer be completely opened. Correspondingly, the system will trigger a local signal which indicates to the person that his motor vehicle is located in the area of the evacuation route, so that this person may park his motor vehicle elsewhere and/or move away from there in the normal case. In the same way, the evacuation route monitoring system will trigger a local alarm if physical objects are placed on the interior of the escape door, for example, pallets, crates, etc. In addition to the person who has brought the physical object into the escape door security area, persons located nearby will also be made aware by the local alarm. In addition, the local alarm may be chronologically adjustable, and after this predefined time span has expired, the system may be implemented to trigger a main alarm, for example, by transmitting a corresponding signal to a building monitoring central office. Overall, higher security against blocking of the evacuation route and/or the escape door by physical objects standing in the way is thus ensured.

The escape door security area is preferably predefined in such a way that it covers the area which the escape door requires for swinging open and closed, so that blocking of the escape door is avoided. In addition, it is to be ensured when predefining the escape door security area that the area is implemented in such a way that a person who wishes to pass and/or actuate the escape door must penetrate into the escape door security area. It is thus ensured that all persons who intend to actuate the escape door are detected by the monitoring unit before the actuation. Because the escape door security area is predefinable, it is variably adaptable to the particular existing conditions, such as height and width of the corridor and/or room in front of the escape door, size of the escape door, etc. The escape door security area is also flexibly adjustable in regard to detecting at least the area of the evacuation route which must be free of objects of any type in order to guarantee that the evacuation route and/or the escape door are not blocked.

The escape door security area is expediently situated in direct proximity to the escape door. This does not mean that it absolutely has to be situated adjoining the escape door.

However, it is important that the distance between escape door and escape door security area is not so large that they lose their functional connection. A general spatial monitoring of a space adjoining the escape door is not in direct functional connection with the escape door, for example, and may not be used as a monitoring system for the escape door security area. For example, a person penetrating into the escape door security area is to be able to connect the triggering of the local signal with his approach to the escape door. This is not the case if escape door and escape door security area are too far apart from one another.

The monitoring unit may, in principle, be any unit known from the prior art which is capable of monitoring a spatial area as to whether objects are located in this area. In addition to the monitoring unit, the system preferably also comprises a control unit, which is in data communication with the monitoring unit and which analyzes the data ascertained and/or measured by the monitoring unit. This function may also be implemented as directly integrated in the monitoring unit. Furthermore, an output unit is expediently provided for outputting the local signal. This output unit may also be implemented as integrated in the monitoring unit. The monitoring unit, the control unit, and the output unit are expediently situated in proximity to the escape door and may be both surface mounted and also flush mounted.

Of course, multiple escape doors may also be provided within an evacuation route, a system according to the present invention then being situated on every escape door.

Alternatively, it is also possible to provide a single networked system, at least one monitoring unit then being situated on every escape door, which transmits the ascertained data to a central control unit. Furthermore, an output unit for outputting a local signal is to be provided on every escape door. The term “local signal” is to be understood to mean that the signal is output locally at least in the area of the escape door and/or in the area of the escape door security area, so that a penetrating person, and/or a person who brings a physical object into the escape door security area may perceive this local signal. In principle, the local signal may also be output in such a way that it is perceivable beyond the escape door security area, for example, by persons being located in proximity to the escape door security area, it being ensured that the output is locally restricted in such a way that the persons perceiving the local signal may produce a connection between the escape door and/or the escape door security area and the signal. The signal is preferably output in the form of an alarm and is also referred to as a precursor alarm, which triggers before the main alarm, which, for example, is triggered upon actuation of an escape door using a separate system, for example, a contact mechanism between door and door frame. The main alarm is normally triggered in the entire building or in an alarm central office, while the precursor alarm is restricted to a local alarm in the area of the location of origination.

In principle, the escape door security area may be situated in the escape direction before the escape door, after the escape door, or on both sides. The escape door security area is preferably situated in the escape direction before the escape door. This configuration is expedient, since escape doors are normally openable at any time only in the escape direction and thus the greatest danger of unauthorized passage arises from here. Opposite to the escape direction, the escape doors are often only actuatable using corresponding contrivances, such as keys or key cards, and thus locked to unauthorized persons. In addition, the escape door security area may also be expanded to this side of the escape door, however. This is expedient if blocking of the escape door by physical objects or similar items placed without consideration is to be expected because of the conditions existing on this side.

To prevent the system from also outputting the local signal when authorized persons pass the escape door, and/or step into the escape door security area or bring physical objects therein, an access control unit is expediently provided. If it is recognized by the access control unit that a person or also a physical object has an access authorization, for example, a key, a key card, a transponder, a PIN code, etc., the output of the local signal by the system is suppressed as a reaction thereto. Furthermore, a main alarm which is normally to be output upon unauthorized opening of the escape door may also be suppressed in this case. A person having access authorization may thus pass the escape door and/or an object may be present in the escape door security area without the local signal and/or a main alarm being triggered. In principle, the access control unit may query both an authorization for the actuation of the escape door and also an authorization for the passage of the escape door security area. Thus, for example, janitorial personnel may have an authorization for passage of the escape door security area for cleaning purposes, but not an authorization to actuate the escape door, however. In this case, the local signal would only be triggered upon actuation of the escape door, but not upon passage of the escape door security area.

The access control unit may also be implemented as a personal identification unit, so that it may be precisely established which persons have actuated the escape door and/or passed the escape door security area at which time. In principle, all units known from the prior art and suitable for use with the system may be used as the access control unit. Thus, for example, the access control unit may also be remote controllable, for example. The local signal may be suppressed for a predefined time span which is normally required by a person to pass through the escape door security area and pass the escape door, for example. Alternatively, the suppression of the local signal may also be stopped when the monitoring unit recognizes that the access-authorized object has left the escape door security area again. It is also possible that the monitoring unit checks whether the escape door is closed again after the authorized opening. If the escape door is perceived as the object present in the escape door security area, the escape door is open, if it is not perceived, the escape door is closed. Of course, the escape door security area must be laid out appropriately for this embodiment. If the door also remains open beyond a predefined time span, the system may output a local alarm and/or transmit a signal to a building monitoring central office to trigger a main alarm. In the last variation, it is advantageous in particular that a separate system for status checking of the escape door may thus be dispensed with. If the escape door security area is implemented on both sides of the escape door, it is expedient to provide an access control unit on each side of the escape door.

Furthermore, it is preferable for the system to be implemented in such a way that it suppresses the output of the local signal as long as the escape door remains in a regular open position. The terms “regular open position” or “regular opening” are to be understood to mean that a person having access control has actuated and opened the escape door. During the opening duration, the local signal is suppressed by the system. This has the advantage that the local signal is not triggered in an undesired way. An example of this is the delivery of products to a building via an evacuation route. The escape door of the evacuation route must be open for the delivery and the system suppresses the output of the local signal, so that the evacuation route may be passed by the delivery personnel without a local signal continuously being triggered. The system may also be implemented so that the state of the regular open position must be triggered separately by a person having access control, to avoid conflicts when the escape door may only remain open for a predefined time span according to an embodiment described above in the event of authorized opening, for example, without a precursor alarm and/or a main alarm being triggered.

In a preferred embodiment of the present invention, a timer and/or a time relay is provided, by which the output of the local signal is temporarily suppressed. This is advantageous since the local signal is thus not output at specific times at which persons routinely pass the escape door security area with authorization. An example of this is the cleaning of the evacuation route at regular intervals by cleaning personnel.

The output of the local signal is expediently stopped by the system according to the present invention as soon as an object present in the escape door security area, which has triggered the local signal, has left the escape door security area again. When the object has left the escape door security area again, the desired result, namely that the unauthorized object withdraws and/or is withdrawn from the escape door security area, has occurred, so that maintaining a local signal is no longer necessary.

In a further preferred embodiment, when an object is present in the escape door security area, the system according to the present invention is implemented, in addition to outputting the local signal, to transmit a further signal to one or more external receiver units with which the system is in data communication. The communication between systems according to the present invention and the external receiver units may be both via wires and also wireless. An exemplary application of this embodiment is equipping supervisory or security personnel with handheld devices which may be informed by the system using SMS or via radio that an object without access authorization is present in an escape door security area. The informed supervisory personnel may then take appropriate measures, such as checking the corresponding escape door security area.

At least one receiver unit is advantageously a global building monitoring system. This has the result that a signal arrives at the monitoring central office when a person or a physical object has penetrated into the escape door security area and a main alarm is triggered if necessary. Corresponding measures may then be taken from this central point. If a unit for monitoring the actuation of the escape door is provided at the escape door monitored using the system according to the present invention, which transmits a signal to the global monitoring system in case of an actuation, in this embodiment, the system according to the present invention may use the same communication line as the actuation monitoring unit. Furthermore, it is possible to implement actuation monitoring unit and system according to the present invention as one unit which assumes both functions. In principle, the precursor alarm may thus be implemented independently from the main alarm or combined therewith. The system according to the present invention is then advantageously implemented to transmit a separate signal to the building monitoring system when the escape door is actuated, so that it is possible to differentiate between passage of the escape door security area and actuation of the escape door.

The local signal is preferably output as an acoustic warning signal and alternatively or additionally as a visual warning signal. The acoustic alarm may be output in the form of a signal tone or also in the form of a recorded spoken message which is played as needed, which warns against using the escape door except for emergencies, for example. The visual warning signal may be implemented as a warning or alarm light, for example. The visual alarm is preferably implemented as a warning notice situated in the evacuation route area, which is displayed and/or illuminated upon penetration of an object into the escape door security area. The illumination may be constant or pulsing. Alternatively or additionally, it is preferable, upon penetration of an object into the escape door security area, to give a notification, particularly by illuminating this area, so that the penetrating person and/or the person bringing a physical object into the escape door security area visually perceives the escape door security area and withdraws therefrom.

In a further preferred embodiment, the system according to the present invention is implemented in such a way that the output parameters of the local signal and particularly the intensity of the local signal are adjustable. This means that the output parameters of the system according to the present invention are changeable by technical personnel in the already installed state. The term output parameters is to be understood to mean all properties of the output of the local signal, such as the intensity, the form of appearance, the dimensions, the brightness, the symbols, etc.

In a further preferred embodiment, the regulation of the signal output of the system according to the present invention is implemented in such a way that the intensity of the local signal, such as the brightness of an output light or the volume of an acoustic alarm, increases and/or decreases as a function of external factors. Thus, for example, the intensity of the local signal may be a function of the dwell time of an object in the escape door security area in such a way that the intensity of the local signal increases the longer the object remains in the escape door security area. Furthermore, the intensity may also be implemented as a function of the distance of the object present in the escape door security area to the escape door in such a way that the intensity of the local signal increases the closer the object located in the escape door security area comes to the escape door. For this embodiment, the monitoring unit is to be implemented accordingly, so that it may ascertain the distance of the penetrating object from the escape door.

In addition, the regulation of the signal output of the system according to the present invention may be implemented in such a way that it adaptively tailors the output of the local signal to the existing environmental factors. For this purpose, the system according to the present invention expediently has sensors which ascertain the environmental factors existing in the area of the escape door security area, such as brightness, noise level, etc. The output of the local signal is tailored according to the ascertained values. An example of this is the increase of the volume of a local acoustic signal to be output when the system according to the present invention establishes that the noise level surrounding the escape door security area is relatively high.

In order to make persons already aware of the escape door security area before they pass it and/or before a physical object penetrates therein, it is expedient to provide visual markings in the area of the evacuation route which permanently indicate the escape door security area. This may occur in the form of warning signs or similar things, for example. A unit which visually marks the escape door security area is preferably provided. This is especially preferably achieved using a light projection, a light curtain, and/or laser beams. Such visual markings may additionally advantageously be used as mounting aids in such a way that during the installation of an evacuation route monitoring system or during its calibration, the escape door security area to be monitored is oriented by maintenance or installation personnel on the basis of the visual markings.

The monitoring unit is expediently implemented as an intrusion sensor, particularly as a movement sensor, as a radar unit, or as a visual monitoring unit (e.g., video monitoring system which automatically registers changes in a monitored spatial area). However, any monitoring unit known from the prior art which is suitable for use in the present invention is also usable in principle. A two-dimensional or even three-dimensional escape door security area may accordingly also be monitored as a function of the implementation of the monitoring unit. Light barriers which act in one dimension or similars device may also be used in principle as the monitoring unit. It is also possible to combine multiple individual sensors to form a monitoring unit.

The object is also achieved by a method for deterring persons from actuating an escape door of an evacuation route according to claim 17 and a use of a monitoring unit according to claim 18.

In the following, the present invention is described further on the basis of exemplary embodiments illustrated in the drawing.

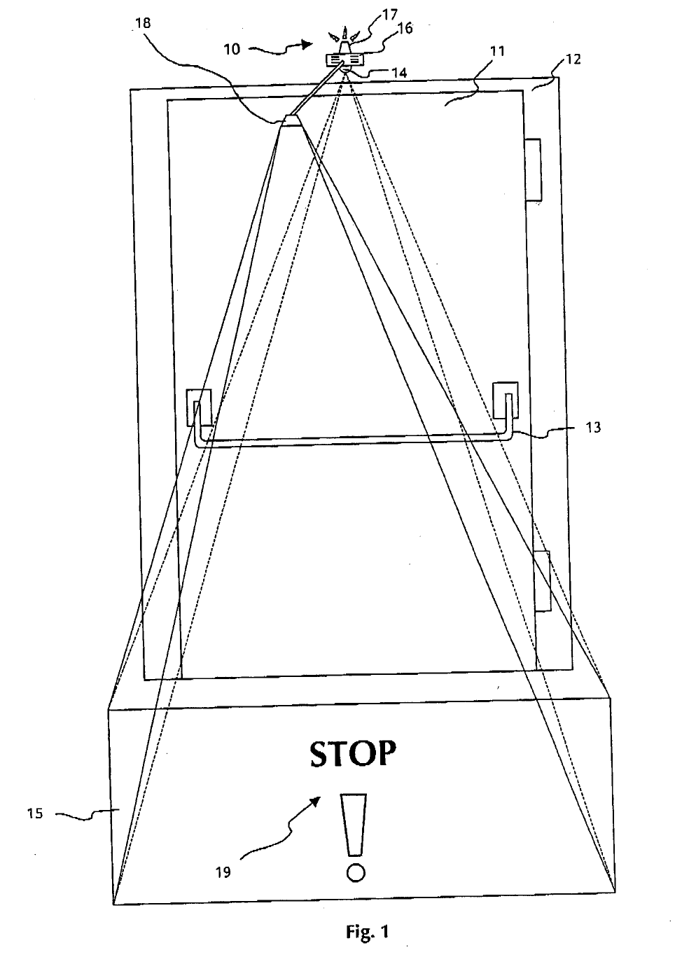

FIG. 1: schematically shows a side view of an escape door having an evacuation route monitoring system situated above the door and an escape door security area which may be illuminated; and

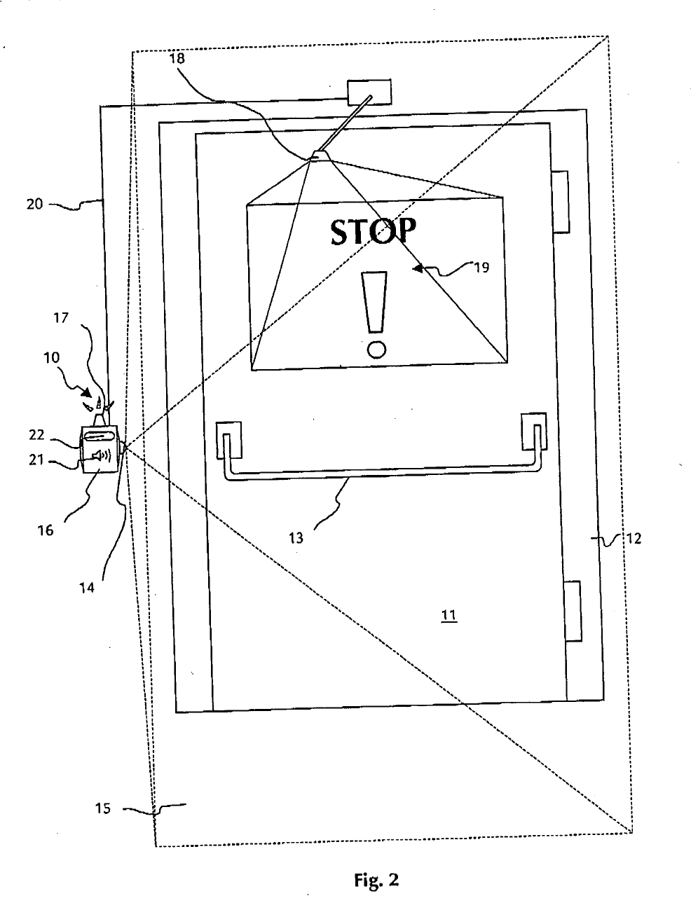

FIG. 2: schematically shows a side view of an escape door having an evacuation route monitoring system and a projectable warning notice on the escape door.

In the various embodiments of the present invention described in the following, identical components are provided with identical reference numerals in the figures.

FIG. 1 shows a side view of an escape door 11 which is situated in an escape door frame 12. An actuation unit, implemented as a push bar 13, is provided on the door 11, by which the escape door 11 may be actuated and opened at any time. The side of the escape door 11 shown is thus the escape or panic side, from which the escape door 11 must be passable at any time. The escape direction thus runs perpendicularly to the escape door plane and therein in the illustration shown in FIG. 1.

An evacuation route monitoring system 10 is situated above the escape door 11. The evacuation route monitoring system 10 comprises a monitoring unit 14, implemented as an intrusion sensor, which monitors an escape door security area 15 situated in front of the escape door 11. The monitoring of the escape door security area 15 by the intrusion sensor 14 is shown using dashed lines. The escape door security area 15 is thus essentially a three-dimensional, pyramid-like area, whose tip is located at the intrusion sensor 14 and whose rectangular base is formed by the floor in front of the escape door 11. If a person or a physical object penetrates into this pyramid-shaped escape door security area 15, this is recognized by the intrusion sensor 14. The escape door security area 15 is predefined in such a way that a person who wishes to actuate the push bar 13 of the escape door 11, and approaches the escape door 11 from the escape side, must penetrate into the escape door security area 15 in any case.

If the intrusion sensor 14 recognizes a penetration into the escape door security area 15, it communicates this to the control unit 16, which is also part of the evacuation route monitoring system 10. The control unit 16 then triggers a local signal. In the evacuation route monitoring system 10 illustrated here, the local signal comprises turning on an alarm lamp or light 17, which is situated adjoining the control unit 16. In addition, the control unit 16 activates a projector 18, which is connected to the control unit 16. This projector 18 projects a visual warning notice 19 as a light projection on the floor in the area in front of the escape door 11. As soon as the penetrating person leaves the escape door security area 15 again, the intrusion sensor 14 communicates this to the control unit 16 and the alarm light 17 is turned off. The projection of the visual warning signal 19 is also stopped.

Furthermore, the projector 18 is implemented so that it may project the outline of the rectangular base area of the pyramid-like security area 15 on the floor lying in front of the escape door 11 in the escape direction. The system according to the present invention may be set in such a way that this outline projection is permanently provided, independently of whether or not a person has penetrated into the escape door security area 15. Persons located in proximity to the escape door 11 are thus already notified before penetrating into the escape door security area 15. The evacuation route monitoring system 10 illustrated here thus outputs two different visual warning signals 19 as a local signal.

FIG. 2 also shows a side view of an escape door 11. In contrast to the illustration from FIG. 1, the evacuation route monitoring system 10 illustrated here is situated laterally next to the escape door 11. The monitoring unit 14, also implemented as an intrusion sensor, monitors an escape door security area 15 which is essentially cuboid, projects beyond the escape door 11 on all sides, and extends therefrom opposite to the escape direction. The escape door security area 15 and the monitoring of this area by the intrusion sensor 14 are illustrated by dashed lines.

The evacuation route monitoring system 10 shown here also outputs the illumination of an alarm light 17 and also the projection of a visual warning notification as a visual warning signal 19. In contrast to the illustration from FIG. 1, the visual warning notification is projected onto the escape door 11. Furthermore, the projector 18 is situated at a distance from the control unit 16 and is connected thereto using a cable 20. The projector 18 is situated above the escape door 11. Moreover, the evacuation route monitoring system 10 outputs an acoustic alarm and/or an acoustic warning signal 21 upon penetration of a person or a physical object into the escape door security area 15. The acoustic warning signal 21 is illustrated here as a loudspeaker symbol.

The evacuation route monitoring system 10 further comprises an access control unit 22, which is implemented as integrated in the control unit 16. This access control unit 22 is implemented to transmit and receive signals. If a person having an access authorization in the form of a transponder (not shown here) corresponding to the access control unit 22 comes into proximity to the access control unit 22, this unit recognizes that an authorized person has arrived and transmits this to the control unit 16. This control unit now ensures that both the visual warning signals 19 and also the acoustic warning signal 21 are suppressed when this person steps into the escape door security area 15. The suppression of the local signal is maintained as long as the authorized person is located in the escape door security area 15.

1. A system for deterring persons from actuating an escape door of an evacuation route, which comprises a monitoring unit, which monitors a predefined escape door security area, which is located directly in the escape direction in front of the escape door, for passage by persons, the escape door security area being predefined in such a way that a person who wishes to pass the escape door in the escape direction must penetrate into the escape door security area, and which, upon passage of the escape door security area by a person, outputs at least a local warning signal to deter the penetrating person from actuating the escape door as long as the person is located in the escape door security area and turns off the local warning signal as soon as the person has left the escape door security area again.

2. The system according to claim 1, characterized in that the system comprises an access control unit and suppresses the output of the local warning signal as a function of an access authorization of a person.

3. The system according to claim 2, characterized in that in the event of a regular opening of the escape door, the system suppresses the output of the local warning signal.

4. The system according to claim 1, characterized in that a timer is provided, using which the system temporarily suppresses the output of the local warning signal.

5. The system according to claim 1, wherein the system transmits a corresponding signal to at least one external receiver unit if a person is present in the escape door security area.

6. The system according to claim 5, wherein the at least one external receiver unit is a global monitoring system.

7. The system according to claim 1, wherein the local warning signal is output acoustically.

8. The system according to claim 1, wherein the local warning signal is output visually.

9. The system according to claim 8, characterized in that the visual warning signal is implemented as a visual warning notification situated in the evacuation route area.

10. The system according to claim 8, characterized in that the visual warning signal is implemented as an illumination of the predefined escape door security area.

11. The system according to claim 1, wherein the output parameters, particularly the intensity, of the local warning signal are adjustable.

12. The system according to claim 1, wherein the system changes the intensity of the local warning signal as a function of the distance of a person located in the escape door security area to the escape door and/or his dwell time in the escape door security area.

13. The system according to claim 1, wherein the system changes the intensity of the local warning signal as a function of the environmental conditions existing in the area of the escape door security area.

14. The system according to claim 1, wherein the system comprises a unit for visually marking the predefined escape door security area.

15. The system according to claim 14, characterized in that the unit visually marks the escape door security area using a light projection, a light curtain, and/or laser beams.

16. The system claim 1, wherein the monitoring unit is implemented as an intrusion sensor, particularly as a movement sensor, as a radar unit, or as a visual monitoring unit.

17. A method for deterring persons from actuating an escape door of an evacuation route, characterized by the following steps:
predefining an escape door security area of the evacuation route directly in front of the escape door in the escape direction, the area being predefined in such a way that a person who wishes to pass the escape door in the escape direction must penetrate into the area;
monitoring this area in such a way that passage of this area by persons is recognized;
outputting a local warning signal to deter the penetrating person from actuating the escape door as soon as passage of the escape door security area is recognized; and
turning off the local warning signal as soon as the person leaves the escape door security area again.

18. A use of a monitoring unit, particularly a movement sensor, a radar unit, or a visual monitoring unit, to deter persons from actuating an escape door of an evacuation route, by monitoring an escape door security area, provided directly in front of the escape door in the escape direction, for passage by persons using the monitoring unit to output a local warning signal upon penetration of a person into the escape door security area to increase the inhibition threshold of the penetrating person against actuating the escape door , the escape door security area being predefined in such a way that a person who wishes to pass the escape door in the escape direction must penetrate into the escape door security area.
